(19) United States
(12) Patent Application Publication
(10) Pub. No.: US 2016/0092103 A1
(43) Pub. Date: Mar. 31, 2016

(54) DISPLAY, MANAGEMENT, AND USE OF ON-SCREEN KEYBOARD

(71) Applicant: Time Warner Cable Enterprises LLC, New York, NY (US)

(72) Inventors: David Rithchey Braden, V, Broomfield, CT (US); Christopher William Dura, Denver, CO (US)

(21) Appl. No.: 14/501,596

(22) Filed: Sep. 30, 2014

(51) Int. Cl. G06F 3/0488; G06F 3/0482; G06F 3/0484

(52) U.S. Cl. CPC G06F 3/04886; G06F 3/04842; G06F 3/0482

(57) ABSTRACT

A display manager initiates display of an on-screen keyboard to include a first zone of display regions and a second zone of display regions on a display screen. The display manager additionally initiates display of a visual prompt that is navigable about the first zone. A location of the visual prompt indicates a current navigation position in the on-screen keyboard. In response to receiving directional input with respect to the visual prompt from a display region in the first zone to a display region in the second zone, the display manager performs a function corresponding to selection of the display region in the second zone. In one example implementation of an on-screen keyboard, a display region represents a letter of the alphabet. Selection of the display region (and corresponding letter) outside of the first zone using an arrow key indicates selection of the letter in the second zone.

### BACKGROUND

Conventional on-screen keyboards typically include a display of symbols such as every letter of the alphabet and integer digits between zero and nine. In addition to displaying letters of the alphabet and integer digits, conventional on-screen keyboards sometimes include display of selectable functions such as a space key, delete key, clear key, etc. Via selection of the displayed symbols in the on-screen keyboard, a respective user is able to create a text string to perform a search.

Typically, to traverse a conventional on-screen keyboard, a respective user operates an arrow keypad on a control device. For example, the conventional on-screen keyboard includes a visual prompt indicating a current location of a selection tool. To move the visual prompt to a different symbol (or different location) on the conventional on-screen keyboard, the user inputs a sequence of one or more up arrow, down arrow, left arrow, right arrow keystrokes to move the visual prompt to a desired location. After moving to the desired location, the user presses the select button (a.k.a., OK button) on the keypad in order to select a respective symbol currently highlighted by the visual prompt.

The user repeats this process of moving the visual prompt to the appropriate symbol and making a selection via the select button to create a respective text string that can then be used to search for content.

### BRIEF DESCRIPTION OF EMBODIMENTS

Conventional on-screen keyboard techniques suffer from deficiencies. For example, conventional on-screen keyboards require a high number of keystrokes in order to create a respective string of text to perform the search.

Embodiments herein deviate with respect to conventional techniques to provide a more useful on-screen keyboard experience.

More specifically, in accordance with one embodiment, a display manager initiates display of an on-screen keyboard to include a first zone of display regions and a second zone of display regions on a display screen. The display manager additionally initiates display of a visual prompt that is navigable about the first zone of display regions. A location of the visual prompt indicates a current navigation position in the on-screen keyboard. In response to receiving directional input with respect to the visual prompt from a display region in the first zone to a display region in the second zone, the display manager performs a function corresponding to selection of the display region in the second zone.

In one example embodiment, one or more of the display regions is assigned a corresponding symbol such as a letter of the alphabet, a number, a menu option, etc. Display of a respective symbol in a display region indicates a function assigned to the display region.

A keypad to traverse the on-screen keyboard can include an up arrow key, a down arrow key, a left arrow key, a right arrow key, as well as a selection button (a.k.a., OK button). Via input to the keypad, the respective user is able to select different display regions and corresponding symbols. Based on the selected display region and corresponding symbol, the display manager performs an appropriate function.

In contrast to conventional techniques, via arrow keys and selection keys on the remote control device, the novel on-screen keyboard as described herein input increases efficiency by requiring less over-all key strokes. For example, the techniques as described herein increase a speed of text entry based on use of the navigation input itself (such as selection of an arrow key) as a command to perform the functions such as adding a character to a text string.

These and other more specific embodiments are disclosed in more detail below.

Note that any of the resources as discussed herein can include one or more computerized devices, controllers, set top boxes, servers, base stations, wireless communication equipment, communication management systems, workstations, handheld or laptop computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the steps and operations summarized above and disclosed in detail below. One such embodiment comprises a computer program product including a non-transitory computer-readable storage medium (i.e., any physical computer readable hardware storage medium) on which software instructions are encoded for subsequent execution. The instructions, when executed in a computerized device (e.g., computer processing hardware) having a processor, program and/or cause the processor to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One or more embodiments herein include a computer readable storage medium and/or system having instructions stored thereon. In accordance with one embodiment, the instructions, when executed by computer processor hardware, cause the computer processor hardware (such as in a mobile computer device) to: initiate display of multiple display regions on a display screen, the multiple display regions including a first display region and a second display region, the second display region displaying a symbol; initiate display of a visual prompt in the first display region, the visual prompt indicating a current navigation position in the display screen; and in response to receiving directional input with respect to the visual prompt from the first display region to the second display region, store a copy of the symbol in a buffer to indicate selection of the symbol.

Another embodiment herein includes a computer readable storage medium and/or system having instructions stored thereon. The instructions, when executed by computer processor hardware, cause the computer processor hardware to: initiate display of a first zone of display regions and a second zone of display regions on a display screen; initiate display of a visual prompt, the visual prompt navigable about the first zone of display regions and the second zone of display regions, a location of the visual prompt indicating a current navigation position; and in response to receiving directional input with respect to the visual prompt from a display region in the first zone to a display region in the second zone, perform a function corresponding to selection of the display region in the second zone.

The ordering of the operations above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor, or within an operating system or a within a software application.

As further discussed herein, techniques herein are well suited for reducing the amount of input required from a user to create a respective text string. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

FIG. 1 is an example diagram illustrating a processing environment including a keypad, display manager, and an on-screen keyboard according to embodiments herein

FIG. 2 is an example diagram illustrating a first version of an on-screen keyboard according to embodiments herein.

FIGS. 3-6 are example diagrams illustrating use of the first version of the on-screen keyboard to produce a text string according to embodiments herein.

FIG. 7 is an example diagram illustrating use of a generated text string to identify candidate titles according to embodiments herein.

FIG. 8 is an example diagram illustrating a second version of an on-screen keyboard according to embodiments herein.

FIGS. 9-12 are example diagrams illustrating use of the second version of the on-screen keyboard according to embodiments herein.

FIG. 13 is a diagram illustrating an example computer architecture in which to execute any functionality according to embodiments herein.

FIGS. 14 and 15 are example diagrams illustrating methods according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION AND FURTHER SUMMARY OF EMBODIMENTS

In one non-limiting example embodiment, a display manager initiates display of an on-screen keyboard to include a first zone of display regions and a second zone of display regions on a display screen. The display manager additionally initiates display of a visual prompt that is navigable about the first zone. A location of the visual prompt indicates a current navigation position in the on-screen keyboard. In response to receiving directional input with respect to the visual prompt from a display region in the first zone to a display region in the second zone, the display manager performs a function corresponding to selection of the display region in the second zone. In one example implementation of an on-screen keyboard, a display region represents a letter of the alphabet. Selection of the display region (and corresponding letter) outside of the first zone using an arrow key indicates selection of the letter in the second zone.

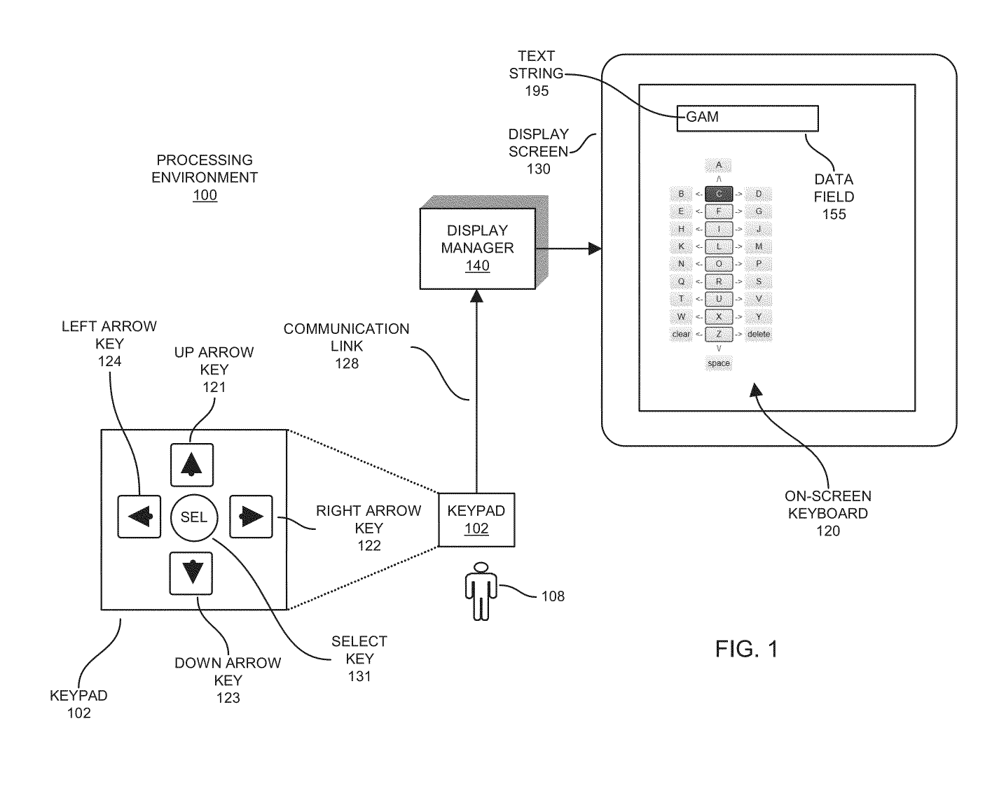

Now, more specifically, FIG. 1 is an example diagram illustrating a corresponding on-screen keyboard and corresponding usage according to embodiments herein.

As shown, the processing environment 100 includes user 108, keypad 102, display manager 140, and display screen 130.

The keypad 102 resides in any suitable type of device such as a handheld remote control device, a computer device, etc., operated by the respective user 108. Communication link 128 can be any suitable type of link such as a wireless link or a wired link between the keypad 102 on the display manager 140.

The display manager 140 resides in any suitable type of device such as a set-top box, a computer device, etc.

The display screen 130 can be any suitable type of device such as a television screen, computer screen, etc.

In this example embodiment, keypad 102 includes up arrow key 121, right arrow key 122, down arrow key 123, and left arrow key 124. Additionally, keypad 102 includes SELECT key 131.

In general, during operation, display manager 140 initiates display of on-screen keyboard 120. User 108 provides input (such as presses respective keys) to keypad 102 to navigate about the on-screen keyboard 120 to produce text string 195 stored in data field 155.

As their names suggests, during operation, selection of the up arrow key 121 enables the respective user 108 to navigate the on-screen keyboard 120 in an up direction; selection of the down arrow key 123 enables the respective user to navigate the on-screen keyboard 120 in a down direction; selection of the right arrow key 122 enables the respective user to navigate the on-screen keyboard 120 in a right direction; selection of the left arrow key 124 enables the respective user 108 to navigate the on-screen keyboard 120 in a left direction.

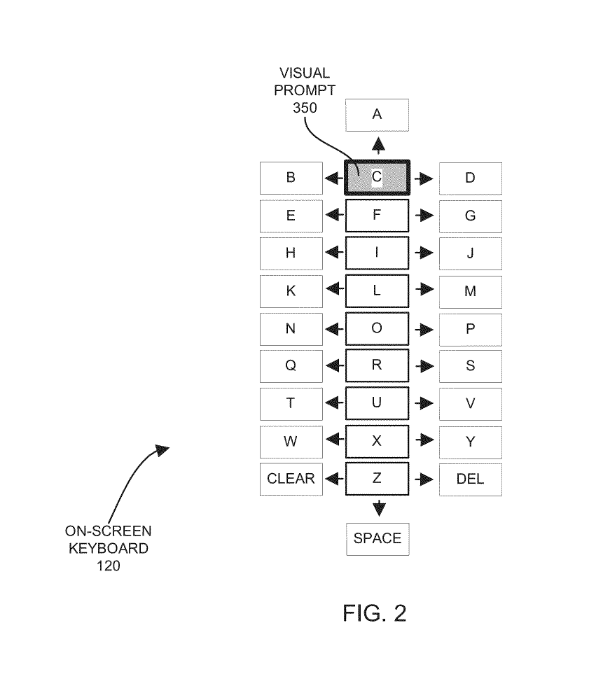

FIG. 2 is a more detailed example diagram of an on-screen keyboard according to embodiments herein.

As shown in this example embodiment of on-screen keyboard 120, the display manager 140 initiates display of multiple display regions on display screen 130. In this example embodiment, the display manager 140 displays display region A (representing the letter A), display region B (representing the letter B), display region C (representing the letter C), display region D (representing the letter D), and so on.

Each display region in the on-screen keyboard 120 includes display of a corresponding symbol such as a letter, a number, a command, etc. For example, a first display region in the on-screen keyboard 120 displays the letter A; a second display region in the on-screen keyboard 120 displays the letter B; a third display region in the on-screen keyboard 120 displays the letter C; the fourth display region and the on-screen keyboard 120 displays the letter D; and so on.

Further in this example embodiment, the on-screen keyboard 120 includes a display region to display a CLEAR command (to clear the text string 195); the on-screen keyboard 120 includes a display region to display a SPACE command (to add a space to the text string 195); the on-screen keyboard 120 includes a display region to display a DEL command (to delete a respective character in the text string 195); and so on.

As further shown, the display manager 140 initiates display of a visual prompt 350 to indicate a current navigation position in the on-screen keyboard 120 displayed on display screen 130.

As further discussed herein, in response to receiving directional input (such as via selection of the arrow keys in keypad 102) with respect to the visual prompt 350 from a first display region to a second display region, the display manager 140 stores a copy of the selected symbol to a buffer. In one embodiment, the buffer (such as a resource in display manager 140) stores text string 195. In response to receiving the directional input such as selection of the right arrow key 122 while the visual prompt 350 is located at display region C, the display manager 140 appends a copy of the letter D to the current text string 195 stored in the buffer. More specifically, in response to receiving the directional input navigating the visual prompt 350 from the display region C to the display region D via selection of the right arrow key 122, the display manager 140 temporarily moves the visual prompt 350 to the display region D (such as for a duration of time such as greater than 500 milliseconds to indicate that the letter D was selected) and thereafter relocates the visual prompt 350 back to the display region C. After the visual prompt 350 is located over display region C again, the user 108 operating the keypad 102 can select the select key 131. In response to receiving selection of the SELECT key 131, the display manager 140 appends the letter C (associated with display region C) to the text string. Accordingly, the functions associated with display regions at the core (or center) of the on-screen keyboard 120 can be selected using the select key 131. Outlier display regions with respect to the core or center of the on-screen keyboard 120 can be selected via the arrow keys.

Thus, in a similar manner, when the visual prompt 350 is located at any one of the corresponding display regions in the core or center of on-screen keyboard 120 (such as display region C, display region F, display region I, display region on L, display region 0, display region R, display region U, display region X, and display region Z), selection of an arrow key from keypad 102 results in selection of a symbol (letter, command, etc.) associated with the outlier display region with respect to the core.

In this example embodiment, after selection of a respective arrow key, the display manager 140 records selection of a respective symbol and then relocates the visual prompt 350 back to its original location. This alleviates the user from having to press two arrow keys to select the letter D. In other words, to select the letter D, assuming that the visual prompt 350 starts at the display region C, conventional technology would require that the user select a right arrow key to move the visual prompt to display region D; press the SELECT key 131 to select the letter D; and then press the left arrow key 124 to move the visual prompt 350 back to the display region C. In contrast, embodiments herein include a display manager 140 configured to record selection of the letter D and corresponding display region D based on a single keystroke such as selection of the right arrow key 122 when the visual prompt 350 is located at the display region C.

Accordingly, embodiments herein enable one to navigate amongst an on-screen keyboard 120 with substantially fewer button presses.

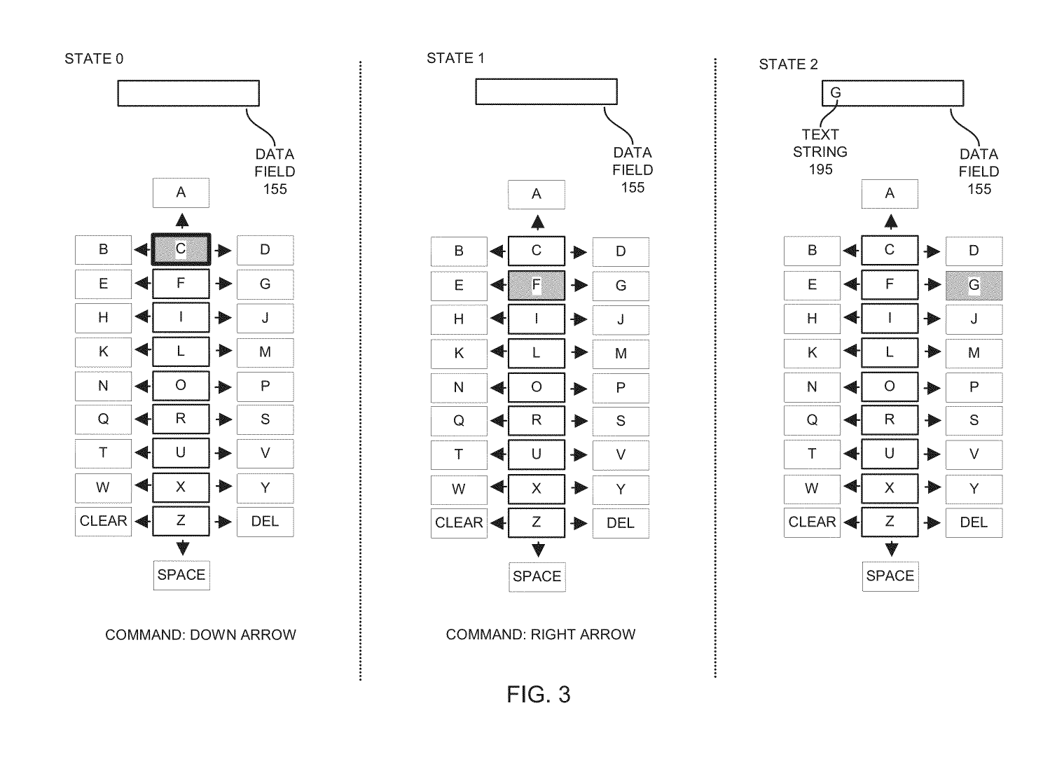

FIGS. 3-6 are example diagrams illustrating use of the first version of the on-screen keyboard to produce a text string according to embodiments herein.

More specifically, in state #0 as shown in FIG. 3, the data field 155 is initially empty. The display manager 140 receives input from the user 108 indicating pressing of the down arrow key 123. In response to receiving selection of the down arrow key 123, the display manager 140 moves the visual prompt 350 to display region F as shown in the following state #1.

In state #1, the display manager 140 receives selection of the right arrow key 122 from a user 108 operating keypad 102. The user 108 presses the right arrow key 122 to select the letter G, which is adjacent to the display region F representing the letter F. In one embodiment, in response to receiving selection of the right arrow key 122 to select the adjacent display region G outside of the core (or zone) of display regions (C, F, I, L, O, R, U, X, Z) as previously discussed, the display manager 140 temporarily moves the visual prompt 350 outside of the core to display region G as shown in state #2.

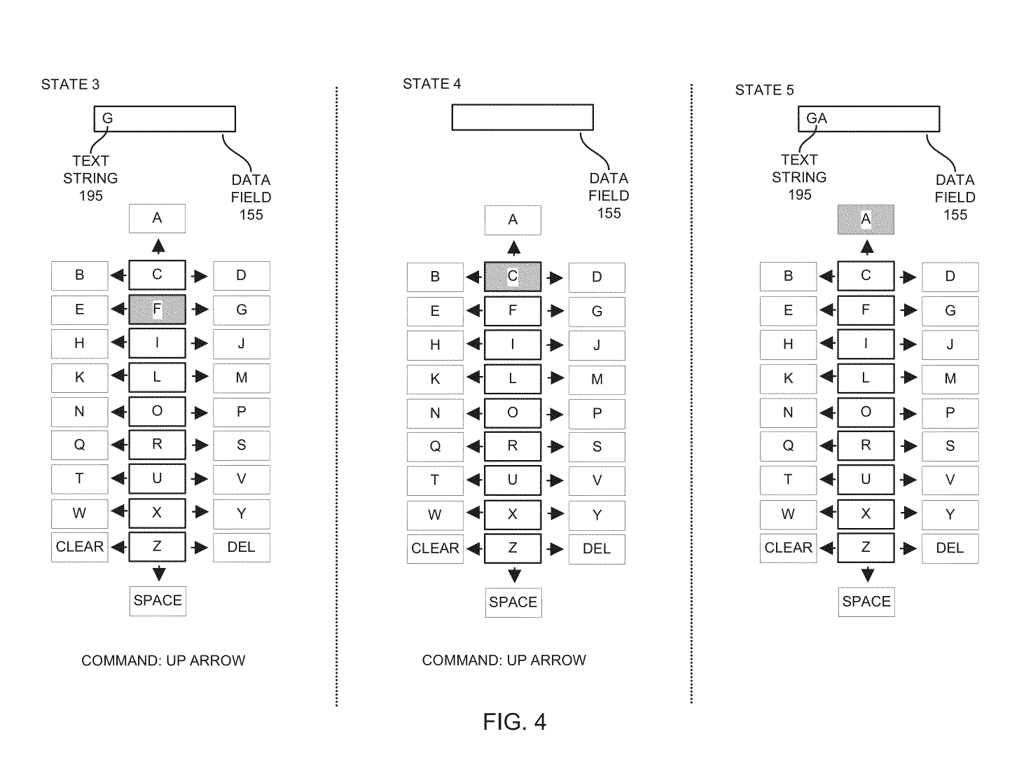

In state #2, without further selection of an additional key on the keypad 102, the display manager 140 appends a copy of the selected letter G to the text string 195 presented in data field 155. After a duration of time such as one second in state #2, the display manager 140 moves the visual prompt 350 back to display region F as shown in the following state #3 in FIG. 4.

In state #3, the user 108 presses the up arrow key 121 on keypad 102. The display manager 140 receives the inputted up arrow command. In response to receiving the up arrow command while in state #3, the display manager 140 moves the visual prompt 350 to display region C as shown in state #4.

While in state #4, the display manager 140 receives selection of the up arrow key 121 selected by the user 108 operating keypad 102. The user 108 presses the up arrow key 121 to select the letter A. In one embodiment, in response to receiving selection of the up arrow key 121, the display manager 140 temporarily moves the visual prompt 350 to display region A as shown in state #5.

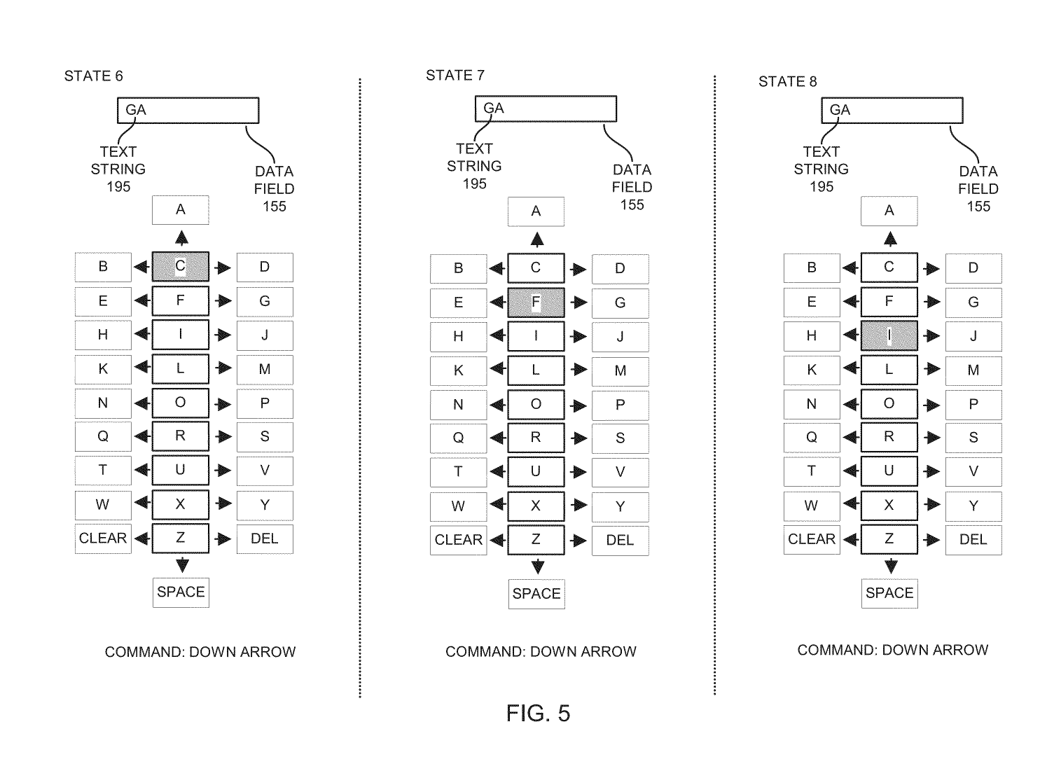

In state #5, without further selection of an additional key on the keypad 102, the display manager 140 appends a copy of the selected letter A to the text string 195 (to create the text string “GA”) stored in data field 155 as shown. After a duration of time such as one second in state # 5, the display manager 140 automatically (without further input from the user 108) moves the visual prompt 350 back to display region C as shown in the following state #6 of FIG. 5.

In state #6, the user 108 presses the down arrow key 123 on keypad 102. The display manager 140 receives the down arrow command. In response to receiving the down arrow command, the display manager 140 moves the visual prompt 350 to display region F as shown in state #7.

In state #7, the user 108 presses the down arrow key 123 on keypad 102. The display manager 140 receives the down arrow command. In response to receiving the down arrow command while in state #7, the display manager 140 moves the visual prompt 350 from display region F to display region I as shown in state #8.

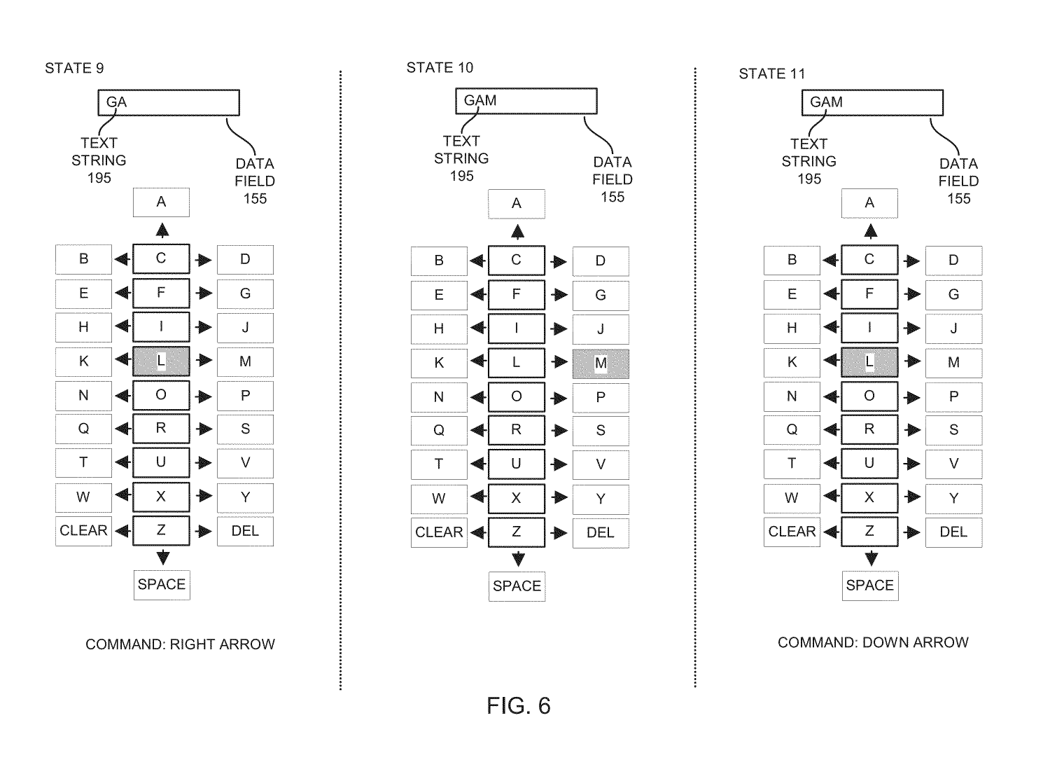

In state #8, the user 108 presses the down arrow key 123 on keypad 102. The display manager 140 receives the down arrow command. In response to receiving the down arrow command while in state #8, the display manager 140 moves the visual prompt 350 from display region Ito display region L as shown in state #9 of FIG. 6.

While in state #9, the display manager 140 receives selection of the right arrow key 122 selected by the user 108 operating keypad 102. The user 108 presses the right arrow key 122 to select the letter M. In one embodiment, in response to receiving selection of the right arrow key 122 while in state #9, the display manager 140 temporarily moves the visual prompt 350 to display region M as shown in state #10.

In state #10, without further selection of an additional key on the keypad 102, the display manager 140 appends a copy of the selected letter M to the text string 195 (to create the text string “GAM”) stored in data field 155 as shown. After a duration of time such as one second in state #10, the display manager 140 moves the visual prompt 350 back to display region L as shown in the following state #11.

In this manner, the respective user 108 is able to navigate about the on-screen keyboard 120 via input to keypad 102. As previously discussed, selection of a respective arrow key while the visual prompt 350 is located within a column or row of core display regions (such as display region C, display region F, display region I, display region on L, display region O, display region R, display region U, display region X, and display region Z) results in selection of the respective outlier display region and corresponding function with respect to the core.

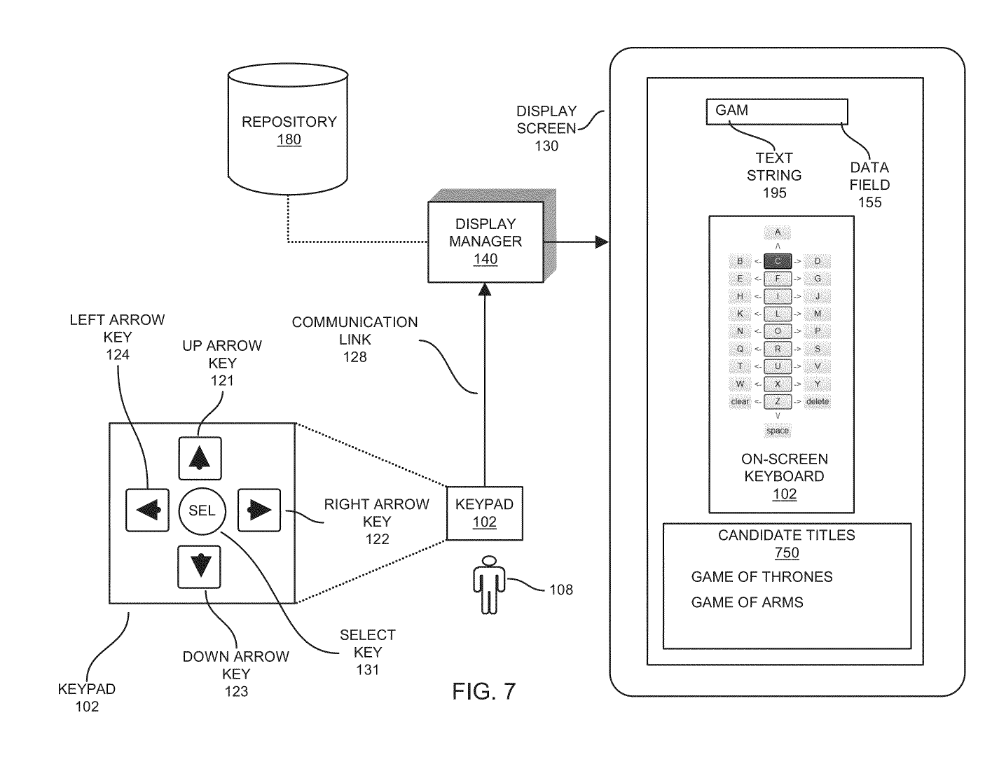

FIG. 7 is an example diagram illustrating use of a generated text string to identify candidate titles according to embodiments herein.

As further discussed herein, the current text string 195 (such as the first 3 letters “GAM” in this example) can be used for any suitable purpose such as performing a search for content in a repository 180. In one embodiment, the display manager 140 matches the text string 195 stored in the data field 155 to multiple titles of candidate content (candidate text strings) to which the text string 195 potentially pertains.

In this example embodiment, the display manager 140 detects that the text string 195 in data field 155 is present in candidate titles 750 including GAME OF THRONES, GAME OF ARMS, etc.

Thereafter, the display manager 140 initiates display of the multiple candidate titles 750 (candidate text strings including GAME OF THRONES, GAME OF ARMS, etc.) on the display screen 130 for selection by the user 108.

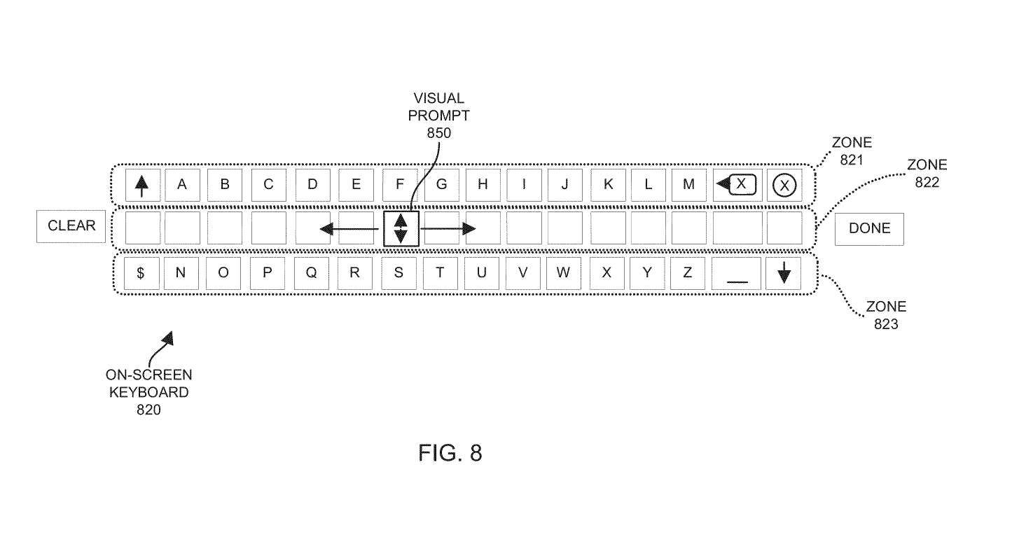

FIG. 8 is an example diagram illustrating a second version of an on-screen keyboard according to embodiments herein.

In this example embodiment, the on-screen keyboard 820 can be used in lieu of on-screen keyboard 120 to perform commands such as create a respective text string, perform a search, clear a string of text, delete a character, etc.

As shown, on-screen keyboard 820 includes multiple zones including zone 821, zone 822, and zone 823.

Each of the zones includes multiple display regions. For example, zone 821 includes a sequence (such as a row substantially parallel to an X-axis or horizontal axis) of display regions including display region A, display region B, display region C, display region D, etc.

Zone 823 includes a sequence (such as a row substantially parallel to an X axis or horizontal axis) of display regions including display region $, display region N, display region O, display region P, etc.

Zone 822 includes a sequence (such as a row, column, etc., substantially parallel to an X axis) of blank display regions, one of which is populated with the visual prompt 850 to indicate a current navigation location in the on-screen keyboard 820.

In this example embodiment, an axial length of zone 821 is side-by-side and substantially parallel with respect to an axial length of zone 822; for an axial length of zone 823 is side-by-side and substantially parallel with respect to an axial length of zone 822.

On-screen keyboard 820 optionally includes CLEAR and DONE functions adjacent to zone 822. Selection of the CLEAR function and corresponding display region clears the text string 195 in data field 155. Selection of the DONE function and corresponding display region indicates to the display manager 140 that the user 108 has completed creation of the corresponding text string 195.

In one embodiment as shown, the visual prompt 850 includes one or more arrows.

To indicate selection options, each of the one or more arrows points in a direction substantially orthogonal to an axial length of a sequence of display regions in zone 822. For example, the first arrow in the visual prompt 850 points upward to selectable display region F in zone 821; a second arrow in the visual prompt 850 points in a down direction to display region S in zone 823.

During operation, the user 108 operates keypad 102 to move the visual prompt 852 to the left or right of its current position along the horizontal axis. In response to detecting selection of the left arrow key 124, the display manager 140 moves the visual prompt 850 to the next adjacent display region along the horizontal axis to the left of its current position; in response to detecting selection of the right arrow key 122, the display manager 140 moves the visual prompt 850 to the next adjacent display region along the horizontal axis to the right of its current position. Accordingly, the user 108 is able to navigate the visual prompt 850 in a direction substantially parallel to the horizontal axis using the left and right arrow keys.

To select a respective display region (and corresponding function) in zone 821 or zone 823, the user 108 selects respective up arrow key 121 or down arrow key 123. In other words, to select a respective display region in zone 821 or zone 823, user 108 selects a respective key such as the up arrow key 121 or down arrow key 122 indicating to move the visual prompt 850 (at least temporarily) in a direction substantially orthogonal with respect to an axial length of zone 822.

As a more specific example, in response to detecting selection of the up arrow key 121, the display manager 140 can be configured to temporarily move the visual prompt 850 in the corresponding of direction to indicate the selection in the on-screen keyboard 820. For example, to select display region F (corresponding to the letter F) in zone 822, the user 108 viewing the on-screen keyboard 820 presses the up arrow key 121. To select display region S (corresponding to the letter S) in zone 823, the user 108 viewing the on-screen keyboard 820 presses the down arrow key 123.

In one embodiment, selection of the leftmost display region in zone 821 (displaying the arrow) causes the on screen keyboard 822 to switch to displaying a sequence of integer values between zero and nine instead of letters of the alphabet. In a similar manner, the user 108 can navigate a respective visual prompt to select one or more integers.

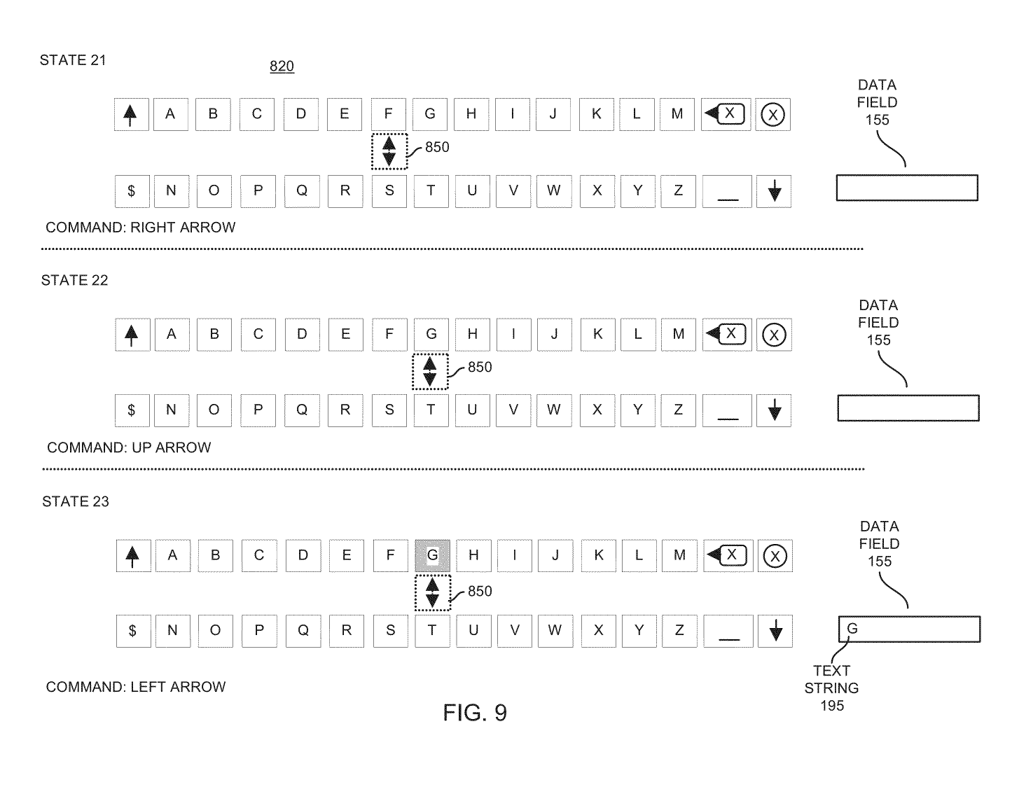

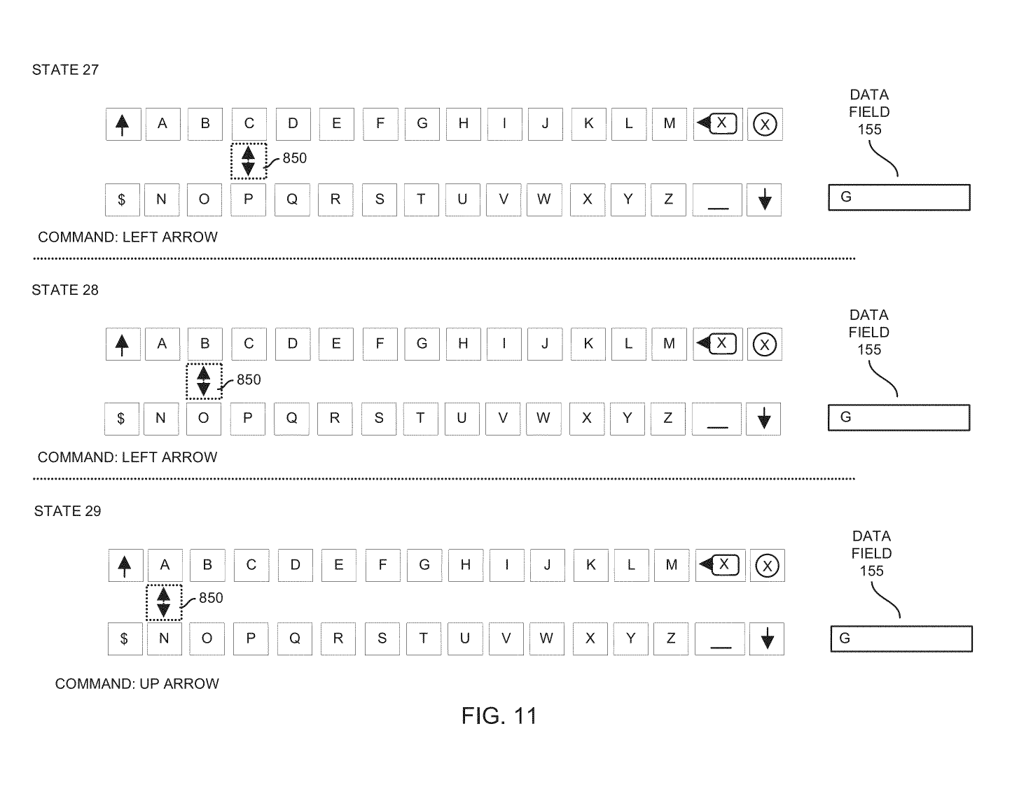

FIGS. 9-12 are example diagrams illustrating use of the second version of the on-screen keyboard according to embodiments herein.

In state #21, data field 155 is empty. Assume in this example embodiment that the visual prompt 850 resides between display region F and display region S as shown. User 108 presses the right arrow key 122 on keypad 102. In response to receiving this right arrow selection, the display manager 140 moves the visual prompt 850 to the right by one unit in zone 822 such that the visual prompt 850 resides between display region G and display region T as shown in state #22.

While in state #22, assume that the user 108 presses the up arrow key 121 to select display region G and corresponding letter. In response to receiving selection of the display region G and corresponding letter, the display manager 140 provides a visual indication (such as highlighting, shading, etc.) in state #23 that the display region G and corresponding letter have been chosen by the user 108. Additionally, as further shown in state #23, in response to receiving selection of the display region G, the display manager appends the letter G to the text string 195 stored in data field 155. After a duration of time such as one second in state #23 in which the display region G is highlighted, the display manager 140 discontinues providing a visual indication that the G was selected.

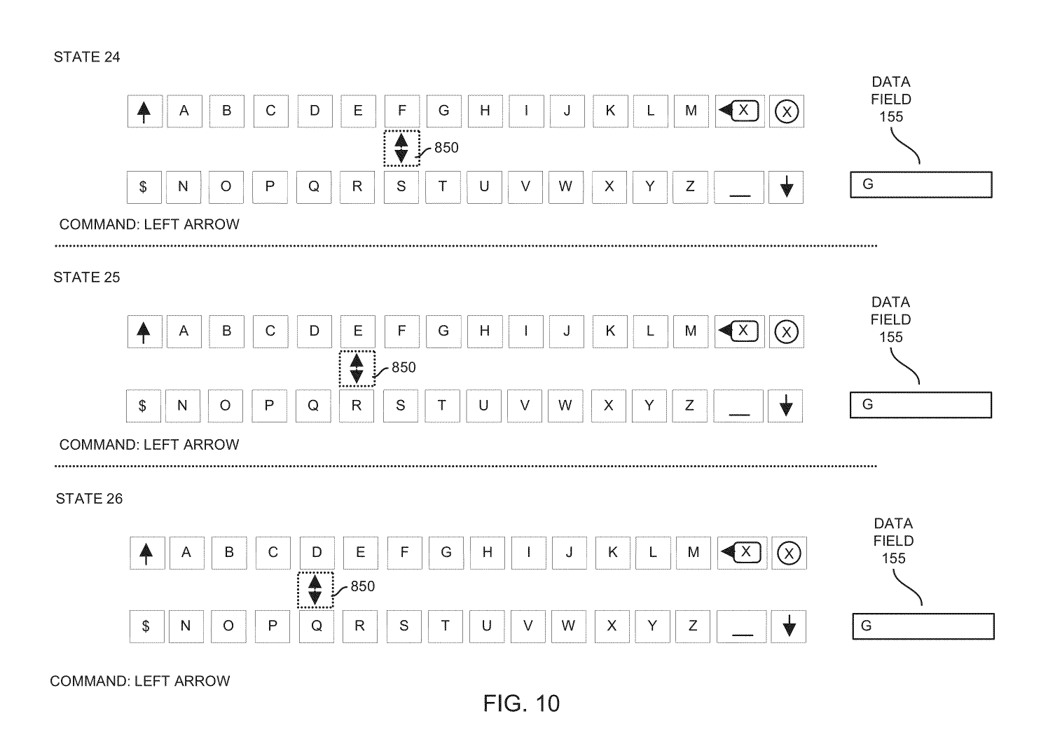

Further, while in state #23, assume that the user 108 operates keypad 102 and selects left arrow key 124. In response to receiving selection of the left arrow key 124, the display manager 140 moves the visual prompt 850 to the left by one unit such that the visual prompt 850 now resides between display region F and display region S as shown in state #24 of FIG. 10.

While in state #24, assume that the user 108 operates keypad 102 and selects left arrow key 124. In response to receiving selection of the left arrow key 124, the display manager 140 moves the visual prompt 850 to the left by one unit such that the visual prompt 850 now resides between display region E and display region R as shown in state #25.

While in state #25, assume that the user 108 operates keypad 102 and selects left arrow key 124. In response to receiving selection of the left arrow key 124, the display manager 140 moves the visual prompt 850 to the left by one unit such that the visual prompt 850 now resides between display region D and display region Q as shown in state #26.

While in state #26, assume that the user 108 operates keypad 102 and selects left arrow key 124. In response to receiving selection of the left arrow key 124, the display manager 140 moves the visual prompt 850 to the left by one unit such that the visual prompt 850 now resides between display region C and display region P as shown in state #27.

While in state #27, assume that the user 108 operates keypad 102 and selects left arrow key 124. In response to receiving selection of the left arrow key 124, the display manager 140 moves the visual prompt 850 to the left by one unit such that the visual prompt 850 now resides between display region B and display region O as shown in state #28.

While in state #28, assume that the user 108 operates keypad 102 and selects left arrow key 124. In response to receiving selection of the left arrow key 124, the display manager 140 moves the visual prompt 850 to the left by one unit such that the visual prompt 850 now resides between display region A and display region N as shown in state #29.

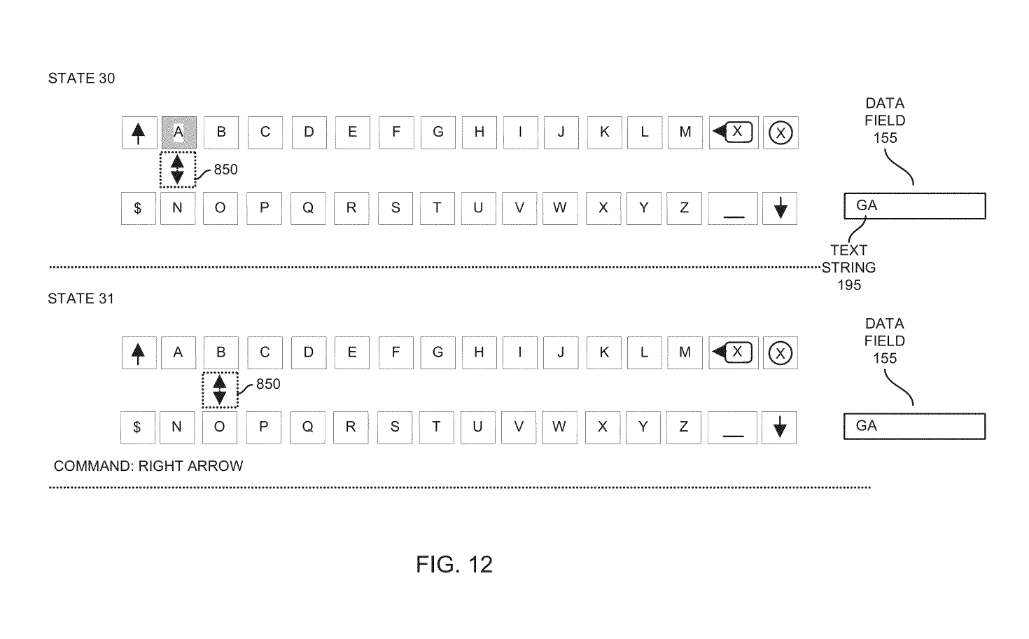

While in state #29, assume that the user 108 presses the up arrow key 121 to select display region A and corresponding letter. In response to receiving selection of the display region A and corresponding letter, the display manager 140 provides a visual indication (such as highlighting, shading, etc.) in state #30 of FIG. 12 that the display region A and corresponding letter have been chosen by the user 108. Additionally, as further shown, in response to receiving selection of the display region A, the display manager appends the letter A to the text string 195 stored in data field 155. After a duration of time such as one second in state #30 in which the display region A is highlighted, the display manager 140 discontinues providing a visual indication that the letter A was selected.

Further, while in state #30, assume that the user 108 operates keypad 102 and selects right arrow key 122. In response to receiving selection of the right arrow key 122, the display manager 140 moves the visual prompt 850 to the right by one unit such that the visual prompt 850 now resides between display region B and display region O as shown in state #31.

In this manner, the user 108 operates keypad 102 to navigate the visual prompt 850 about the on-screen keyboard 820 to create the text string 195 in data field 155. In a similar manner as previously discussed, the display manager 140 can be configured to use the text string 195 to identify matching titles and display them on a respective display screen 130.

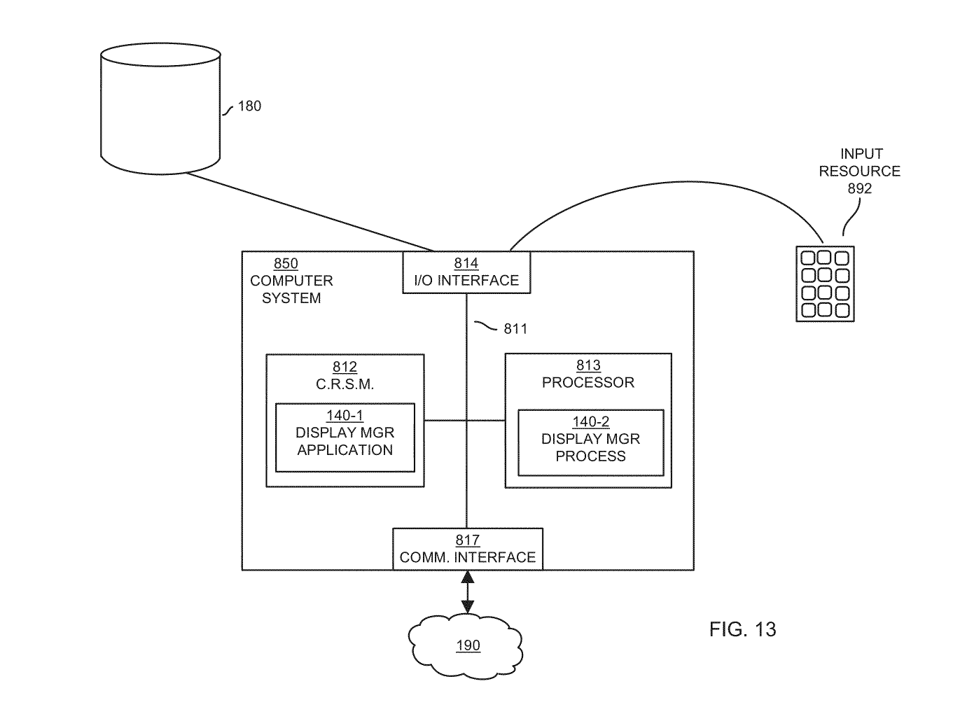

FIG. 13 is an example block diagram of a computer device for implementing any of the operations as discussed herein according to embodiments herein.

In one embodiment, display manager 140 is implemented by one or more computers such as computer system 850 to carry out one or more operations as discussed herein.

As shown, computer system 850 of the present example includes an interconnect 811, a processor 813 (such as one or more processor devices, computer processor hardware, etc.), computer readable storage medium 812 (such as hardware storage to store data), I/O interface 814, and communications interface 817.

Interconnect 811 provides connectivity amongst processor 813, computer readable storage media 812, I/O interface 814, and communication interface 817.

I/O interface 814 provides connectivity to a repository 180 and, if present, other devices such as a playback device, display screen, input resource 892 (such as keypad 102), a computer mouse, etc.

Computer readable storage medium 812 (such as a non-transitory hardware medium) can be any hardware storage resource or device such as memory, optical storage, hard drive, rotating disk, etc. In one embodiment, the computer readable storage medium 812 stores instructions executed by processor 813.

Communications interface 817 enables the computer system 850 and processor 813 to communicate over a resource such as network 190 to retrieve information from remote sources and communicate with other computers. I/O interface 814 enables processor 813 executing display manager 140 to retrieve stored information such as from repository 180.

As shown, computer readable storage media 812 is encoded with display manager application 140-1 (e.g., software, firmware, etc.) executed by processor 813 (hardware). Display manager application 140-1 can be configured to include instructions to implement any of the operations as discussed herein.

During operation of one embodiment, processor 813 (e.g., computer processor hardware) accesses computer readable storage media 812 via the use of interconnect 811 in order to launch, run, execute, interpret or otherwise perform the instructions in the display manager application 140-1 stored on computer readable storage medium 812.

Execution of the display manager application 140-1 produces processing functionality such as display manager process 140-2 in processor 813. In other words, the display manager process 140-2 associated with processor 813 represents one or more aspects of executing display manager application 140-1 within or upon the processor 813 in the computer system 850.

Those skilled in the art will understand that the computer system 850 can include other processes and/or software and hardware components, such as an operating system that controls allocation and use of hardware resources to execute display manager application 140-1.

In accordance with different embodiments, note that computer system may be any of various types of devices, including, but not limited to, a wireless access point, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device. The computer system 850 may reside at any of one or more locations or can be included in any suitable one or more resource in network environment 100 to implement functionality as discussed herein.

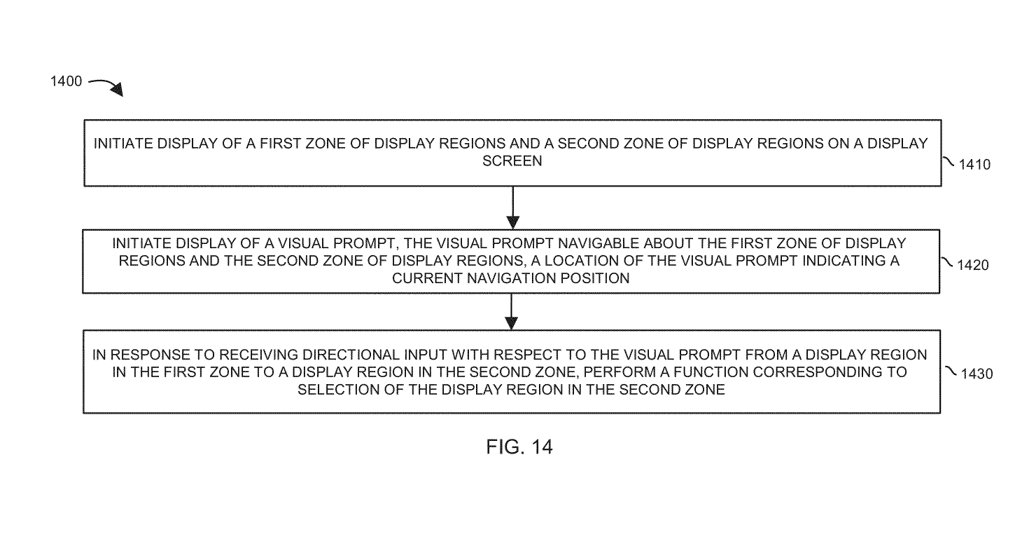

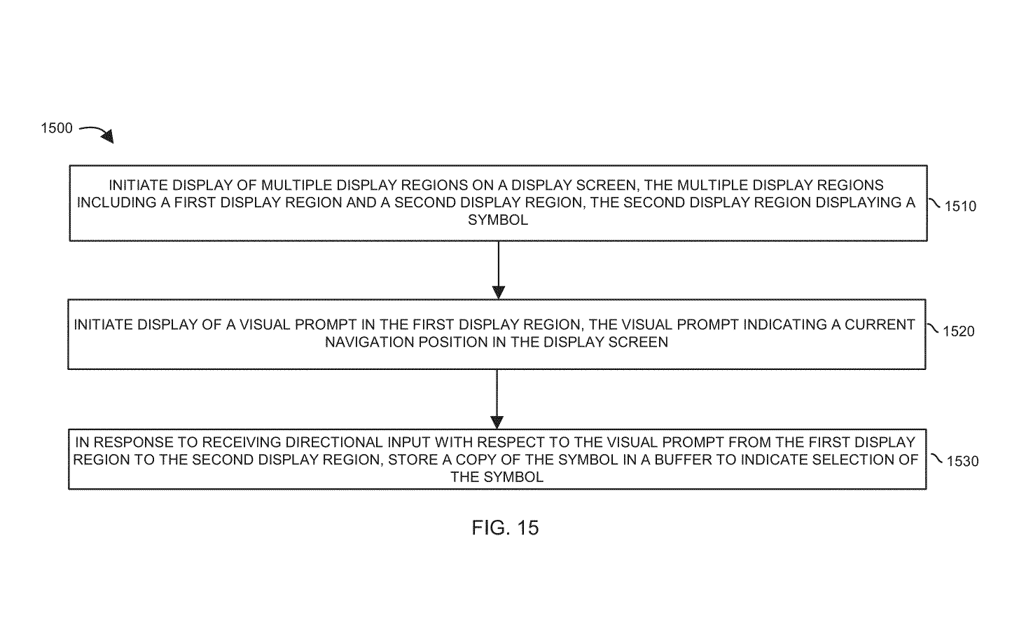

Functionality supported by the different resources will now be discussed via flowcharts in FIGS. 14 and 15. Note that the steps in the flowcharts below can be executed in any suitable order.

FIG. 14 is a flowchart 1400 illustrating an example method according to embodiments. Note that there will be some overlap with respect to concepts as discussed above.

In processing block 1410, the display manager 140 initiates display of multiple display regions on a display screen 130. The multiple display regions includes a first display region (such as display region C) and a second display region (such as display region D). The second display region D displays a symbol (letter D).

In processing block 1420, the display manager 140 initiates display of a visual prompt 350 in the first display region. The visual prompt indicates a current navigation position in the on-screen keyboard 120 displayed on display screen 130.

In processing block 1430, in response to receiving directional input with respect to the visual prompt 350 in a direction from the first display region to the second display region, the display manager 140 stores a copy of the symbol D in a buffer to indicate selection of the symbol D.

FIG. 15 is a flowchart 1500 illustrating an example method according to embodiments. Note that there will be some overlap with respect to concepts as discussed above.

In processing block 1510, the display manager 140 initiates display of a first zone of display regions and a second zone of display regions on a display screen 130. In one embodiment, the first zone (such as a column, row, etc.) of display regions includes display region C, display region F, display region I, display region L, display region O, display region R, display region U, display region X, display region Z. The second zone (such as a column, row, etc.) of display regions includes display region D, display region G, display region J, display region M, display region P, display region S, display region V, display region Y, display region DEL (command for delete character).

In processing block 1520, the display manager 140 initiates display of a visual prompt 350. The visual prompt 350 is navigable about the first zone of display regions and the second zone of display regions in the on-screen keyboard 120. A location of the visual prompt 350 indicates a current navigation position in the on-screen keyboard displayed on display screen 130.

In processing block 1530, in response to receiving directional input with respect to the visual prompt 350 from a display region in the first zone to a display region in the second zone, the display manager 140 performs a function corresponding to selection of the display region in the second zone. As an example, assuming that the visual prompt 350 currently resides in display region Z of the on-screen keyboard 120, receipt of the directional input such as selection of the right arrow key 122 on keypad 102 causes the display manager 140 to initiate performance of the delete command as represented by display region DEL.

Note again that techniques herein are well suited for reducing a number of button presses required to perform a respective functions such as produce a respective text string. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
initiating display of multiple display regions on a display screen, the multiple display regions including a first display region and a second display region, the second display region displaying a symbol;
initiating display of a visual prompt in the first display region, the visual prompt indicating a current navigation position in the display screen; and
in response to receiving directional input with respect to the visual prompt from the first display region to the second display region, storing a copy of the symbol in a buffer to indicate selection of the symbol.

2. The method as in claim 1 further comprising:
in response to receiving the directional input with respect to the visual prompt from the first display region to the second display region: after temporarily moving the visual prompt to the second display region, moving the visual prompt back to the first display region.

3. The method as in claim 2, further comprising:
displaying the multiple display regions on the display screen as part of an on-screen keyboard; and
wherein the directional input is received from a user viewing the display screen and performing a search for content.

4. The method as in claim 3, wherein the directional input is a selection of an arrow key by the user; and
wherein storing the copy of the symbol includes appending the copy of the symbol to a text string stored in the buffer.

5. The method as in claim 4 further comprising:
matching the text string stored in the buffer to multiple candidate text strings to which the text string stored in the buffer potentially pertains; and
initiating display of the multiple candidate text strings on the display screen for selection by the user.

6. The method as in claim 1 further comprising:
in response to receiving the directional input with respect to the visual prompt from the first display region to the second display region as indicated by a selected arrow control key, appending a copy of the symbol associated with the second display region to a text string stored in the buffer.

7. The method as in claim 1, wherein the second display region is disposed adjacent to the first display region on the display screen, the directional input being selection of a respective arrow key to at least temporarily navigate the visual prompt from the first display region to the second display region.

8. The method as in claim 1, wherein the symbol displayed in the first display region is a first symbol of the alphabet, the method further comprising:
in the second display region, initiating display of a second symbol of the alphabet; and
initiating display of a third display region, the third display region displaying a third symbol of the alphabet.

9. The method as in claim 8 further comprising:
appending a copy of the symbol associated with the second display region to a text string stored in the buffer in response to receiving the directional input as indicated by selection of a first arrow key; and
in response to receiving additional input selecting the first display region, appending a copy of the symbol associated with the first display region to the text string stored in the buffer.

10. The method as in claim 1 further comprising:
in response to receiving selection of a first key selection inputted by a user viewing the display screen: i) temporarily moving the visual prompt from the first display region to the second display region, ii) moving the visual prompt back to the first display region, and iii) appending the symbol to a text string stored in the buffer; and
in response to receiving selection of a second key selection inputted by the user viewing the display screen: i) maintaining the visual prompt in the first display region, and ii) appending a symbol assigned to the first display region to the text string.

11. The method as in claim 1, wherein the directional input is a single selection of an arrow key on a keypad, the method further comprising:
in response to receiving the single selection of the arrow key navigating the visual prompt from the first display region to the second display region, performing a back-and-forth transition of the visual prompt from the first display region to the second display region and back to the first display region.

12. The method as in claim 1, wherein the directional input is first input indicating to navigate the visual prompt in a first direction along a first axis, the method further comprising:
in response to receiving second input to navigate the visual prompt in a second direction along a second axis that is substantially orthogonal to the first axis, moving the visual prompt in a direction from the first display region to a third display region without modifying the buffer.

13. The method as in claim 12, wherein the second axis is substantially orthogonal to the first axis.

14. A method comprising:
initiating display of a first zone of display regions and a second zone of display regions in an on-screen keyboard displayed on a display screen;
initiating display of a visual prompt, the visual prompt navigable about the first zone of display regions and the second zone of display regions, a location of the visual prompt indicating a current navigation position; and
in response to receiving directional input with respect to the visual prompt from a display region in the first zone to a display region in the second zone, performing a function corresponding to selection of the display region in the second zone.

15. The method as in claim 14, wherein initiating display of the first zone of the display regions and the second zone of display regions further comprises:
displaying the first zone of display regions as a first sequence; and
displaying the second zone of display regions as a second sequence, the second zone of display regions displayed substantially side-by-side and parallel with respect to the first sequence.

16. The method as in claim 15, wherein the input is selection of a first arrow key on a respective keypad, the first arrow key indicating to move the visual prompt in a direction substantially orthogonal with respect to an axis of the first sequence.

17. The method as in claim 16, wherein the first zone of display regions includes a first display region and a second display region, the first display region disposed in the first sequence adjacent to the second display region, the method further comprising:
in response to receiving additional input navigating the visual prompt from the first display region in the first zone to the second display region in the first zone, moving the visual prompt from the first display region to the second display region.

18. The method as in claim 17, wherein the additional input is selection of a second arrow key on the respective keypad, the second arrow key indicating to move the visual prompt in a direction substantially parallel with respect to the axis of the first sequence.

19. The method as in claim 14 further comprising:
providing an indication that each of the display regions in the first zone corresponds to a respective letter of the alphabet; and
providing an indication that each of the display regions in the second zone corresponds to a respective letter of the alphabet.

20. The method as in claim 14 further comprising:
providing an indication that each of the display regions in the first zone corresponds to a respective letter of the alphabet; and
providing an indication that each of the display regions in the second zone does not correspond to a respective letter of the alphabet.

21. The method as in claim 15 further comprising:
displaying the visual prompt indicating the current navigation position to include an arrow, the arrow pointing in a direction substantially orthogonal to an axial length of the first sequence, the arrow pointing from the display region in the first zone to the display region in the second zone.

22. The method as in claim 14 further comprising:
in response to receiving the directional input, performing a back-and-forth navigation transition of the visual prompt from the display region in the first zone to the display region in the second zone back to the display region in the first zone.

23. A computer system comprising:
computer processor hardware; and
a hardware storage resource coupled to the computer processor hardware, the hardware storage resource storing instructions that, when executed by the computer processor hardware, causes the computer processor hardware to perform operations of:
initiating display of multiple display regions on a display screen, the multiple display regions including a first display region and a second display region, the second display region displaying a symbol;
initiating display of a visual prompt in the first display region, the visual prompt indicating a current navigation position in the display screen; and
in response to receiving directional input with respect to the visual prompt from the first display region to the second display region, and performing an operation as specified by the symbol.

24. The computer system as in claim 23, wherein the computer processor hardware further performs operations of:
in response to receiving the directional input with respect to the visual prompt from the first display region to the second display region: after temporarily moving the visual prompt to the second display region, moving the visual prompt back to the first display region.

25. The computer system as in claim 24, wherein the computer processor hardware further performs operations of:
displaying the multiple display regions on the display screen as part of an on-screen keyboard; and
wherein the directional input is received from a user viewing the display screen and performing a search for content.

26. The computer system as in claim 25, wherein the directional input is a selection of an arrow key by the user; and
wherein performing an operation as specified by the symbol includes appending a copy of the symbol to a text string stored in a buffer.

27. The computer system as in claim 26, wherein the computer processor hardware further performs operations of:
matching the text string stored in the buffer to multiple candidate text strings to which the text string in the buffer potentially pertains; and
initiating display of the multiple candidate text strings on the display screen for selection by the user.

28. The computer system as in claim 23, wherein the computer processor hardware further performs operations of:
in response to receiving the directional input with respect to the visual prompt from the first display region to the second display region as indicated by a selected arrow control key, appending a copy of the symbol associated with the second display region to a text string stored in the buffer.

29. The computer system as in claim 23, wherein the second display region is disposed adjacent to the first display region on the display screen, the directional input being selection of a respective arrow key to at least temporarily navigate the visual prompt from the first display region to the second display region.

30. The computer system as in claim 23, wherein the symbol displayed in the first display region is a first symbol of the alphabet, the computer processor hardware further performing operations of:
in the second display region, initiating display of a second symbol of the alphabet; and
initiating display of a third display region, the third display region displaying a third symbol of the alphabet.

31. The computer system as in claim 30, wherein the computer processor hardware further performs operations of:
appending a copy of the symbol associated with the second display region to a text string stored in a buffer in response to receiving the directional input as indicated by selection of a first arrow key; and
in response to receiving additional input selecting the first display region, appending a copy of the symbol associated with the first display region to the text string stored in the buffer.

32. The computer system as in claim 23, wherein the computer processor hardware further performs operations of:
in response to receiving selection of a first key selection inputted by a user viewing the display screen: i) temporarily moving the visual prompt from the first display region to the second display region, ii) moving the visual prompt back to the first display region, and iii) appending the symbol to a text string stored in a buffer; and
in response to receiving selection of a second key selection inputted by the user viewing the display screen: i) maintaining the visual prompt in the first display region, and ii) appending a symbol assigned to the first display region to the text string.

33. The computer system as in claim 23, wherein the directional input is a single selection of an arrow key on a keypad, the computer processor hardware further performing operations of:
in response to receiving the single selection of the arrow key navigating the visual prompt in a direction from the first display region to the second display region, performing a back-and-forth transition of the visual prompt from the first display region to the second display region and back to the first display region.

34. The computer system as in claim 23, wherein the directional input is first input indicating to navigate the visual prompt in a first direction along a first axis, the computer processor hardware further performing operations of:
in response to receiving second input to navigate the visual prompt in a second direction along a second axis that is substantially orthogonal to the first axis, moving the visual prompt in a direction from the first display region to a third display region without modifying a text string.

35. The computer system as in claim 23, wherein the second axis is substantially orthogonal to the first axis.

36. Computer-readable storage hardware having instructions stored thereon, the instructions, when carried out by computer processor hardware, causes the computer processor hardware to perform operations of:
initiating display of a first zone of display regions and a second zone of display regions in an on-screen keyboard displayed on a display screen;
initiating display of a visual prompt, the visual prompt navigable about the first zone of display regions and the second zone of display regions, a location of the visual prompt indicating a current navigation position; and
in response to receiving directional input with respect to the visual prompt from a display region in the first zone to a display region in the second zone, performing a function corresponding to selection of the display region in the second zone.
